(19) United States
(12) Patent Application Publication
(10) Pub. No.: US 2005/0163931 A1
(43) Pub. Date: Jul. 28, 2005

(54) Orientation coating method of the top of micro tip

(76) Inventors: Ningsheng Xu, Guangdong Province (CN); Shaozhi Deng, Guangdong (CN); Juncong She, Guangdong (CN); Jun Chen, Guangdong (CN)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/508,128

(22) PCT Filed: Jul. 12, 2002
(86) PCT No.: PCT/CN02/00495

(30) Foreign Application Priority Data
Mar. 20, 2002 (CN) 02114979.8

(51) Int. Cl. B05D 1/36; B05D 5/00

(52) U.S. Cl. 427/258; 427/282

(57) ABSTRACT

This invention relates to a method for locally depositing coatings on microtip apex. The technical procedures are listed as following. (1) Using parting layer to cover the tip body and only leave the apex protruded A parting layer was deposited on the entire microtip sample surface. The film thickness is thicker than the height of microtip. By thinning the parting layer, the tip apex was exposed, but the body remains being covered. The height of the exposed tip apex can be controlled by adjusting the thinning parameters. (2) Surface cleaning and passivation treatment Surface cleaning and passivation treatment are performed on the apex of the microtip according to actual needs. (3) Coating Based on actual needs, a selected functional thin film is coated on the microtip sample. (4) Remove the parting layer to form the locally coated tip By using an etchant that only react with the parting layer but not the microtip and the coated material, the parting layer can selectively removed, leave a locally coated microtip. Using the aforementioned method, it is able to perform surface cleaning and locally thin film depositing on microtip apex.

### TECHNICAL FIELD

This invention relates to a method for locally depositing coatings on apex of microtip.

### PRIOR ART

Microtip can be used for a variety of applications, i.e., field electron emission source, micro-probe of SPM (AFM/STM) instruments, and micro-drill for bio-medical analysis. In recent years, with the fast development of modem technology, especially those in nanotechnology, it is desirable to fabricate robust microtip devices with high performance. For example, vacuum microelectronics researchers hope to deposit efficient field electron emitting thin film (such as amorphous diamond) locally on apex of microtip emitters to obtain high performance electron sources. Surface science experts desire to have microtip with ultra-clean apex surface, especially those without native oxides or adsorptions for high resolution and low noise analyzing. Meanwhile, biochemists wish to deposit layers of wear resistant material on apex of the microtip to increase its mechanical strength. They also wish to use microtip as carrier of reactants for micro biochemical analysis and reaction. Moreover, it is expected to grow vertical aligned nanomaterials such as carbon nanotube, tungsten nanowires locally on microtip apex, which has nanometer scale diameter and radius. These integrated devices of tip-nanomaterial configuration have promising potential application in future nanotechnologies.

Earlier techniques for coated microtip have two major disadvantages.
(i) non-locally deposited: the previous techniques can only obtain microtips with thin film on the entire sample surface. The entire thin film coated surface will bring difficulties for practical devices application. For example: (1) the functional area for microtip electron emitters is their apex. The existence of thin film on tip sidewalls and base between tips have very less contribution for the emission. They may form unstable emission sites, which can affect the emission stability and reliability. (2) if the entire sample surface of microtip is covered with catalysts film, it is impossible to control the growth of nanomaterial right on the tip apex for SPM probe application. Therefore, it is essential to locally deposit thin film on tip apex.
(ii) Non-cleaning surface: currently, most of the microtips are made of semiconductor or refractory metal such as silicon, molybdenum or tungsten. These materials can be easily oxidized in air to form an native oxide layer on surface. The oxide layer on tip surface not only can hinder the emission of electrons from microtips but also can produce noise for the microtip SPM probe during the analysis.

### OBJECT OF THE INVENTION

The present invention intends to provide a technique that can overcome the aforementioned advantages of previous microtip coated techniques to obtain (i) microtips with clean apex surface; (ii) coatings be locally deposited just on tip apex.

### TECHNICAL SOLUTION ADOPTED IN THE INVENTION

The method for locally depositing coatings on apex of microtip, as adopted in this invention, can be realized by the following steps:
(1) Using parting layer to cover the tip body and only leave the apex protruded A parting layer was deposited on the entire microtip sample surface. The film thickness is thicker than the height of microtip. By thinning the parting layer, the tip apex was exposed, but the body remains being covered. The height of the exposed tip apex can be controlled by adjusting the thinning experimental parameters.
(2) Surface cleaning and passivation treatment Surface cleaning and passivation treatment are performed on the apex of the microtip according to actual needs.
(3) Coating Based on actual needs, a selected functional thin film is coated on the microtip sample.
(4) Remove the parting layer to form the locally coated tip By using an etchant that only react with the parting layer but not the microtip and the coated material, the parting layer can be selectively removed, leave a locally coated microtip.

Using the method described in this invention, it is able to perform (i) surface cleaning and passivation treatment right at the microtip apex surface; (2) it can obtain microtip with different types thin films deposited right on apex of microtip. Depending on the coated material used, the locally coated microtip would have different functions. For example, by using wear resistant material, it is able to have a wear resistant layer locally on the microtip apex to form a robust microdrill/probe. By using catalyst material, it is able to grow nanomaterials locally on tip apex. The products can be used for applications such as micro biochemical, surface analysis experiments and field electron emission sources.

From the perspective of creativity, this invention can realize locally cleaning and thin film depositing at microtip apex, with good uniformity. From the perspective for practical application, the technique provided in this invention can be used to produce uniform locally coated microtip devices in 4˜6 inches wafer, and the processes are compatible to modern semiconductor integrate circuits manufacture techniques, which is an important advantage for realizing low-cost mass productions.

### CAPTIONS OF THE FIGURES

FIG. 1 is the illustration of the fabrication procedure for locally depositing coatings on apex of the microtip described in the present invention.

FIG. 2 is the typical scanning electron microscope (SEM) image (×7000 in magnification) of the locally coated microtips that obtained using the method developed in the present invention. The coating on the apex is amorphous diamond.

FIG. 3 is the typical scanning electron microscope (SEM) image (×10000 in magnification) of the locally coated microtips that obtained using the method developed in the present invention. The coating on the apex is amorphous diamond.

FIG. 4 is the typical scanning electron microscope (SEM) image (×30000 in magnification) of the locally coated microtips that obtained using the method developed in the present invention. The coating on the apex is amorphous diamond.

FIG. 5 is the typical high-resolution transmission electron microscope (HRTEM) images of the Si/a-D interface (tip apex region) that with prior surface cleaning process, indicated a well Si/a-D junction. The inset is that of the locally coated microtip sample without prior cleaning, showing clear Si/SiO₂/a-D sandwich structure.

FIG. 6 is the local area X-ray energy dispersive distribution analysis spectra of the interface between silicon and amorphous diamond thin film, demonstrated that there is no oxide material existed at the interface.

FIG. 7 is the typical field electron emission I-E curve and corresponding F-N plot of the amorphous diamond locally coated silicon microtip array.

FIG. 8 is the typical field electron emission I-t characteristic of amorphous diamond locally coated silicon microtip array.

FIG. 9 is the typical SEM image of the microtip that with nanoparticles locally located on apex (1).

FIG. 10 is the typical SEM image of the microtip that with nanoparticles located on apex (2).

FIG. 11 is the X-ray energy dispersive distribution analysis spectra of nanometer particles on top of microtip.

### DETAIL DESCRIPTION OF THE PREFERRED EMBODIMENT

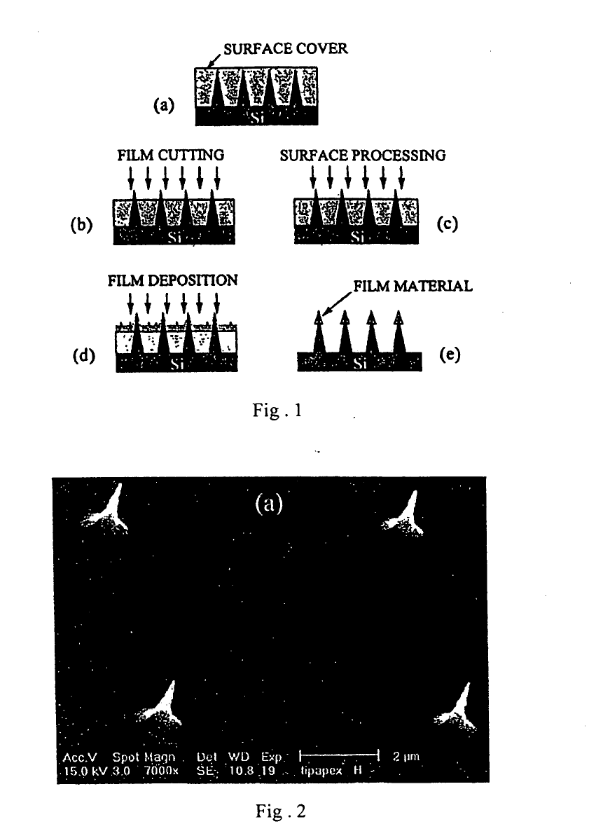

As shown in FIG. 1, the present invention adopts the following steps for locally cleaning (or passivation) and depositing coatings on apex of microtip.

The method for locally depositing coatings on apex of microtip, as adopted in this invention, can be realized by the following steps:
(1) Using parting layer to cover the tip body and only leave the apex protruded A parting layer was deposited on the entire microtip sample surface. The film thickness is thicker than the height of microtip. By thinning the parting layer, the tip apex was exposed, but the body remains being covered. The height of the exposed tip apex can be controlled by adjusting the thinning parameters.
(2) Surface cleaning and passivation treatment Surface cleaning and passivation treatment are performed on the apex of the microtip according to actual needs.
(3) Coating Based on actual needs, a selected functional thin film is coated on the microtip sample.
(4) Remove the parting layer to form the locally coated tip By using an etchant that only react with the parting layer but not the microtip and the coated thin film, the parting layer can selectively removed, leave a locally coated microtip.

The method provided in this invention has the following applications:
1. Perform local surface treatment on microtip shape probe;
2. Locally coat functional films on apex of the microtip;
3. Locally grow nanomaterial on apex of the microtip;
4. Manufacturing microtip shape probe arrays that with different functional materials of apexes.

The following are two examples showing the detail embodiment of the method provided by this invention.

### EXAMPLE 1

This example shows the method for locally depositing thin films on apex of microtip array.
1. Silicon microtip arrays were fabricated on 2 inch (100) silicon wafer.
2. Employ a spin coater (Karl Suss R8), an uniform AZ 5200NJ positive photoresist (PR) layer was coated on the surface of the microtip sample. The spin speed is 3000 rpm, and the duration is 30 seconds.
3. Bake the photoresist coated microtip array at 100° C. for 90 seconds.
4. Employ a photolithography maskaligner (Karl Suss MA4), the PR coated microtip sample was exposed to UV for 1 second.
5. Develop the exposed microtip array sample using developing solution of AZ 300MIF for 20 seconds. After development, the top of the tip is exposed, but the tip body is still covered with photoresist layer.
6. Bake the developed device at 110° C. for 120 seconds.

Note: The processes in step 4˜6 can also be done using the following method: employ magnetic-enhanced reactive ion etching technique and use oxygen as etchant to thin the photoresist layer, the apex of the microtip can also be exposed. The etching power is 250 W, the oxygen flow rate is 40 sccm, and the etching time is 3 minutes.
7. Dip the microtip array in buffer hydrofluoric acid (water: hydrofluoric acid=7:1) for 20 seconds, and then perform a surface treatment on the microtip sample using 100 W H(10 sccm)/Ar(5 sccm) mixed plasma. The time for surface treatment is 5 seconds.
8. Employ filtered vacuum arc iron deposition method to deposit a uniform, ultra-thin (2 nm) layer of amorphous diamond on the surface of micro tip array. The deposition conditions are:
   Bias voltage: −100V
   Temperature: room temperature
   Working vacuum: 10⁻⁵ Torr
9. Liftoff the photoresist layer from the sample surface using ultra purity acetone to obtain Si microtip with uniform amorphous diamond thin film locally located on tip apex.

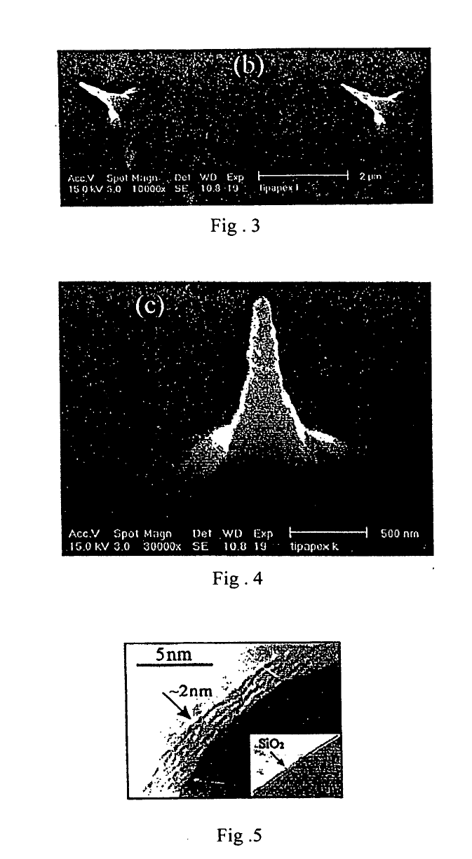

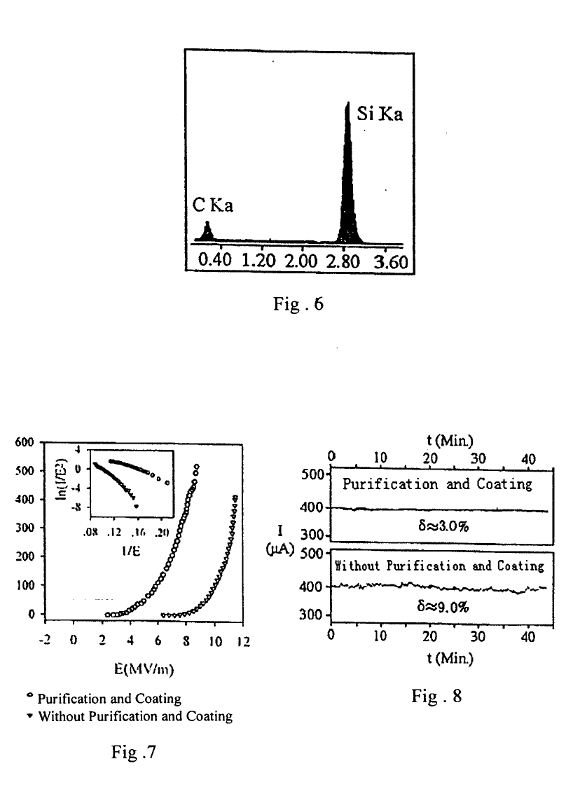

FIGS. 2, 3, and 4 are SEM (scanning electron microscope) images of the silicon microtip device that with uniform amorphous diamond (a-D) thin film locally on tip apex, which is fabricated using the procedure listed above. Obviously, no particle can be observed on the sample surface. FIG. 5 is the typical high-resolution transmission electron microscope (HRTEM) images of the Si/a-D interface (tip apex region) that with prior surface cleaning process, indicated a well Si/a-D junction. Inset of FIG. 5 is that of the locally coated microtip sample without prior cleaning, showing a clear Si/SiO₂/a-D junction. It demonstrated that the cleaning procedure of hydrofluoric acid and H/Ar mixed plasma treatments can effectively remove the native SiO₂ layer to form a well Si/a-D junction. Also it can be found that the a-D thin film on apex is rather uniform and smooth. X-ray energy dispersive distribution analysis spectra (EDX) (indicated in FIG. 6) of the well Si/a-D interface has shown only silicon and carbon elements been detected for the best resolution of the EDX equipment. This further proves that there is no oxidation layer at the interface between the Si/a-D interface which with prior clean treatments. Field electron emission investigations found that the locally a-D coated microtip arrays that with well Si/a-D junction has higher electron emission current density and lower threshold field for electron emission As shown in FIG. 7 and FIG. 8, the threshold field for electron emission of devices with well Si/a-D interface is 3.1 MV/m, and under an electric field of 8.1 MV/m, the emission currency can be reached 400 μA, with the maximum currency fluctuation (Iₘₐₓ-Iₘᵢₙ/400 μA) being only 3.0%; while in the case of devices with Si/SiO₂/a-D junction, it will need to increase the electric field up to 11.5 MV/m to obtain an emission current 400 μA, and the maximum currency fluctuation is relatively higher, i.e, 9.0%. The above results demonstrated that the prior surface cleaning/passivation treatments and the a-D coating locally deposited on microtip apex is a very effective way for obtaining high performance field emission devices.

### EXAMPLE 2

This example shows how to locally grow nanomaterial on apex of individual silicon microtip
1. Fabricate single Si microtips on <100>silicon wafer.
2. Deposit a 1 m layer of aluminum on the surface of Si microtip by using the magnetron-enhanced sputtering system (SP-3, product from microelectronics Center, China Academy of Science). The depositing conditions are as following:
   Sputtering power: 250 W
   Substrate temperature: room temperature
   Depositing vacuum: 5×10⁻⁴ Pa
   Sputtering agent: Ar (60 sccm)
   Time: 20 minutes
3. Employ a spin coater (Karl Suss R8), an uniform AZ 5200NJ positive photoresist (PR) layer was coated on the surface of the microtip sample. The spin speed is 3000 rpm, and the duration is 30 seconds.
4. Bake the photoresist coated microtip array at 100° C. for 90 seconds.
5. Employ a photolithography maskaligner (Karl Suss MA4), the PR coated microtip sample was exposed to UV for 1 second.
6. Develop the exposed microtip array sample using developing solution of AZ 300 MIF for 20 seconds. After development, the top of the tip is exposed, but the tip body is still covered with photoresist layer.
7. Bake the developed device at 110° C. for 120 seconds.

Note: The processes in step 5˜7 can also be done using the following method: employ magnetic-enhanced reactive ion etching technique and use oxygen as etchant to thin the photoresist layer, the apex of the microtip can also be exposed. The etching power is 250 W, the oxygen flow is 40 sccm, and the etching time is 5 minutes.
8. Dip the micro tip device in buffer phosphoric acid solution (water: phosphoric acid=4:1) for 10 minutes. Take it out and wash it using DI water, and then dry it using high purity nitrogen gas.
9. Employ filtered vacuum arc deposition technique to deposit a uniform ultra-thin layer of iron on the sample surface. The depositing conditions are as following:
   Bias voltage: −100V
   Temperature: room temperature
   Working vacuum: 10⁻⁵ Torr
10. Liftoff the photoresist layer using analytic acetone, and then grow nanoparticles on apex of the microtip using CVD method. The detailed steps are as following:
   a) Perform reducing treatment on the sample using hydrogen gas (10 sccm). The treatment duration is 2 hours, and the temperature is 650° C.
   b) Stop providing hydrogen gas. Let in Ar gas (400 sccm) and increase the temperature from 650° C. to 750° C.
   c) Let in acetylene gas (40 sccm) and keep the temperature (750° C.) for 20 minutes.
   d) Stop providing acetylene gas. Stop heating. Let the device cool down in the atmosphere of Ar.
11. Liftoff the aluminum layer using dilute hydrochloric acid (water:dilute hydrochloric acid=5:1). The coating that on top of the aluminum layer could be removed with the Al parting layer. Finally, a device with nanoparticles locally located on microtip apex would achieved.

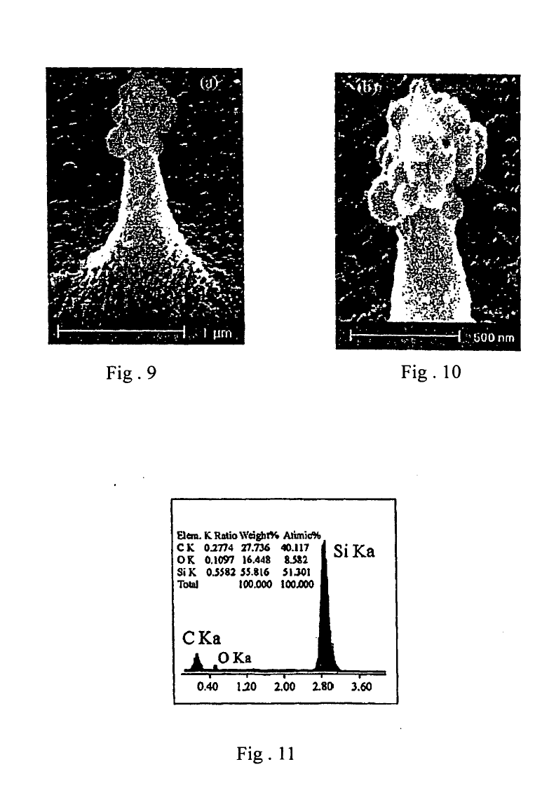

FIG. 9 and FIG. 10 are the scanning electron microscope images of the nanoparticles locally deposited on microtip apex. As shown in these figures, a cluster of nanoparticles are formed at the apex of the microtip that is prior deposited with iron catalyst. The results of EDX analysis proved that the nanocluster on tip apex is carbon particles (see FIG. 11).

1. A method for locally depositing coatings on apex of microtip featuring the following manufacture steps:
(1) Using parting layer to cover the tip body and only leave the apex protruded A parting layer was deposited on the entire microtip sample surface. The film thickness is thicker than the height of microtip. By thinning the parting layer, the tip apex was exposed, but the body remains being covered. The height of the exposed tip apex can be controlled by adjusting the thinning parameters.
(2) Surface cleaning and passivation treatment Surface cleaning and passivation treatment are performed on the apex of the microtip according to actual needs.
(3) Coating Based on actual needs, a selected functional thin film is coated on the microtip sample.
(4) Remove the parting layer to form the locally coated tip By using an etchant that only react with the parting layer but not the microtip and the coated material, the parting layer can selectively removed, leave a locally coated microtip.

2. A method for locally depositing coatings on apex of microtip as described in claim 1, the deposited coating can be functional materials, wear resistant materials, nanomaterials, chemical reactants or catalysts.
